(19) United States
(12) Patent Application Publication
(10) Pub. No.: US 2019/0266690 A1
(43) Pub. Date: Aug. 29, 2019

(54) SYSTEM AND METHODS FOR TRANSPORTATION SYSTEM

(71) Applicant: MARKET2X GROUP LIMITED, Auckland (NZ)

(72) Inventors: Robert John MANDENO, Auckland (NZ); Roger Justin CLAYTON, Auckland (NZ)

(21) Appl. No.: 16/310,743

(22) PCT Filed: Jun. 15, 2017
(86) PCT No.: PCT/NZ2017/050082

§ 371 Date: Dec. 17, 2018

Related U.S. Application Data
(60) Provisional application No. 62/350,623, filed on Jun. 15, 2016.

(51) Int. Cl. G06Q 50/30; G06Q 30/02

(52) U.S. Cl. CPC G06Q 50/30; G06Q 30/0283

(57) ABSTRACT

A method for determining transport or logistic actions includes; receiving a request for transport; receiving availability for a future period of time for a plurality of transport vehicles, obtaining a transport action comprising at least one transport vehicle from the plurality of transport vehicles wherein a characteristic of the transport action such as cost is minimised; confirming availability of a transport vehicle for the transport request; and updating the data relating to future availability of the vehicle. A transport or logistics marketplace is also provided.

### FIELD OF THE INVENTION

The present invention relates to a system for transportation services or logistics which aggregates transport resources to provide and/or optimise the provision of transport resources to transport users. A specific example combines a logistics system and a marketplace to associate a marketplace cost with transportation.

### BACKGROUND

Transportation of goods can be achieved through the use of a plurality of methods, including transport by air, sea and land. A combination of different sources of transportation are possible for each transportation need and these have often been chosen in an ad hoc way. Transport companies can post or agree rates for different transport options based on overall cost estimates or distances between locations. Where multiple transport companies are necessary different estimates are required for each stage, and then must be combined. Furthermore, transport estimates are often dependent on fixed sizes, or a limited choice of options, which may not match the exact product which is to be shipped. Transportation and logistics can become a difficult negotiation between a plurality of different parties with different needs and this, in part, makes price setting for transport difficult. Current transportation systems include separate systems which organise single deliveries—with backhauls where these are clearly available, but often sending vehicles over long distances; and systems which find the best or closest available vehicle for a particular delivery.

U.S. Pat. No. 9,082,144 describes a system in which an automated system is configured to list and accept bids for transportation services. Bids are taken directly from transportation service providers, from brokers and other intermediaries who in turn seek bids from transportation service providers or otherwise obtain bids from transportation service providers and other sources. In addition, the bids can be used for bid estimation, in which participating transportation service providers may be given an opportunity to engage in a reverse auction bid in order to fill a need for obtaining a transportation order. This requires a bidding system in which each transportation service provider is engaged in placing an exact bid for a service. The system also allows estimated arrival times to be provided to users of the system by mobile phone.

U.S. Pat. No. 7,359,862 describes a data processing system intended to facilitate confronting an offer and demand in the field of transporting goods or travellers. In this system requests (offers or demands) are received from users and stored by the system, matched against current orders and an outcome of the request is sent to a user. This broadly describes a method of matching transport services by matching bids and requests already in the system, or providing an option for service providers to add new services to the system. However, each request is treated independently.

U.S. Pat. No. 6,064,981 describes a system in which a website offers an auction block at which anonymous (or identified) buyers and sellers may post and accept bids for shipping given cargo loads over given shipping lanes. In one example, an anonymous buyer makes a bid that may be accepted by a seller (a freight forwarder or carrier). Alternatively, an anonymous or known seller (a forwarder or carrier) may make a bid, e.g., because the entity has additional unused capacity over a given route at a given time, which bid may then be accepted by a buyer (e.g., an anonymous customer). This system allows the transportation users and providers to bid for particular solutions, but details about the required route must be confirmed before a bid is placed.

### OBJECTS OF THE INVENTION

It is an object of the invention to provide a transportation method or logistic engine which provides efficient use of transport vehicles by creating and amending a schedule over a future period of time.

It is an object of the invention to provide a system for transportation services or a logistic system for transport resources which will at least go some way to overcoming disadvantages of existing systems, or which will at least provide a useful alternative to existing systems.

It is an object of the invention to provide a marketplace which is connected to transportation engine so that prices on the marketplace are displayed inclusive of transport costs.

Further objects of the invention will become apparent from the following description.

### SUMMARY OF INVENTION

Accordingly in one aspect the invention may broadly be said to consist in a method for determining transport actions, the method comprising:

Receiving transport provider data from a transport provider; the transport provider data comprising availability for a future period of time for a plurality of transport vehicles;

Storing the transport provider data on a server;

Receiving a transport request from a transport user;

Obtaining a transport action comprising at least one transport vehicle from the plurality of transport vehicles wherein a characteristic of the transport action approaches a selected value;

Receiving confirmation of the at least one transport vehicle for the transport request; and

Updating the transport provider data on the server to include the confirmed transport request.

The method uses a server to store the information of at least one, but preferably a plurality of transport providers in a per vehicle manner. This enables the method to select a transport vehicle in response to a transport request so as to minimise or maximise any one of a plurality of characteristics, including cost or vehicle capacity. By providing the future availability of the vehicle capacity the system is able to gauge forward use of vehicles and, in particular, avoid unnecessary empty movements of vehicles.

A future location of the at least one transport vehicle at a future time can be determined from the transport request, and this data can be added to the transport provider data.

Also, a future capacity of the at least one transport vehicle at a future time can be determined from the transport request, and this data can be added to the transport provider data.

In an embodiment the characteristic of the transport action comprises any one or more of the following:

Time;

Cost;

Efficiency;

Vehicle usage;

Vehicle capacity; and

Vehicle distance travelled.

In an embodiment the approach to a selected value is a maximisation or minimisation. In an embodiment the selected value is zero, or a fixed amount.

In an embodiment the step of obtaining at least one transport action comprises an artificial intelligence or machine learning method. In an embodiment artificial intelligence comprises operations research techniques to solve optimization problems. These techniques may include simulation, mathematical optimization, queueing theory, or neural nets. In an embodiment the techniques comprise the application of machine learning to an optimization problem.

In an embodiment the step of obtaining a transport action comprises applying an action constraint on the solution. In an embodiment the action constraint is based on animal welfare, perishability of load, regulatory constraints, driver time periods, restricted time periods, refrigeration or temperature control.

In an embodiment the future period is at least 1 day. In an embodiment the future period is at least 10 days.

In an embodiment the method comprises providing a transport action to the transport user.

In an embodiment the method comprises the step of receiving a second transport request. In an embodiment the method comprises the step of obtaining a second transport action comprising at least one transport vehicle from the plurality of transport vehicles to reduce a characteristic of the second transport request; and wherein the selection affects or is affected by the first transport action.

In an embodiment the second transport action and the first transport action comprise at least one common transport vehicle.

In an embodiment the method comprises the step of amending a characteristic of the first transport action.

The method is enabled to receive multiple requests for transport vehicle requests and to process these in turn or substantially in parallel. However the second (and any following requests) are potentially affected by the first request. For instance the first request may move one of the vehicles to a different location, making the second request more economical if the same vehicle is used. Alternatively the first and second requests may be able to share a single vehicle.

In an embodiment the method comprises the step of obtaining an amended first transport action. In an embodiment the amended first transport action depends on the second, or further transport action. In an embodiment the method comprises the step of providing the amended first transport action to the transport user. In an embodiment a finalised amended first transport action is provided a time before the pick-up or delivery date of the first transport action.

In an embodiment the method comprises obtaining or calculating a cost for at least one of the transport actions. In an embodiment the cost for the first transport action is adjusted by the confirmation of the second transport action. In an embodiment the cost difference between the cost and the adjusted cost is refunded or rebated to the transport user. In an embodiment the cost difference is prorated or shared between the first and second transport action.

In an embodiment the method comprises the step of recalculating a plurality of transport actions, including the transport action; wherein a characteristic of the transport action is amended; wherein a characteristic of the plurality of transport actions approaches a selected value.

In an embodiment the characteristic of the transport action comprises any one or more of the following:

Time;

Cost;

Efficiency;

Vehicle capacity;

Vehicle usage; and

Vehicle distance.

In an embodiment the method comprises the step of updating the transport provider data includes the step of reporting the updated vehicle position to the transport provider.

In an embodiment the method includes the step of providing details of the transport action to the transport user.

In an embodiment the details are provided to a mobile device. In an embodiment the details are provided as a map.

In an embodiment the stored transport provider data comprises individual data for each of the plurality of transport vehicles.

In an embodiment the method comprises the step of requesting a further transport vehicle from a transport provider; wherein if a transport request cannot be fulfilled with current transport vehicles a further transport vehicle is requested.

In an embodiment the method comprises the step of selecting a single transport action.

In an embodiment the method comprises the step of estimating a delivery date for the transportation action. In an embodiment the method includes the step of the transport user, or service provider receiving one, or a plurality of, delivery dates and/or times.

In an embodiment the transport request comprises one or more request constraints on the transport action.

In an embodiment the one or more request constraints comprises any one or more of the following:

Times or date of delivery;

Time or date of pick-up;

Regulatory constraints;

Amendment limitations;

Access limitations and

Preferred carriers.

In an embodiment the transport provider data comprises any one or more of the following:

Cost per unit distance;

Cost per unit time;

Cost per vehicle action;

Vehicle payload and volume capacity;

Vehicle payload types;

Vehicle start location;

Prior vehicle transport actions;

Vehicle end location;

Vehicle home location;

Vehicle regulations; and

Vehicle load regulations.

In an embodiment the method comprises obtaining a cost for amending a transport action. In an embodiment the cost is additional to the original cost. In an embodiment the amendment is a cancellation, and a cost is calculated.

In an embodiment the method of obtaining a cost comprises calculating a cost difference between the amended and non-amended transport actions. In an embodiment the cost difference reflects an actual cost. In an embodiment the cost is refunded or rebated to the transport user.

In an embodiment the transport action comprises a plurality of transport vehicle. In an embodiment one of the plurality of transport vehicles is a land, air, or sea or water vehicle. In an embodiment the first transport vehicle is carried by, or otherwise associated with, a second transport vehicle.

In an embodiment the server receives a transport request from a remote terminal. Preferably the terminal is a personal computer or mobile electronic device such as a mobile phone or smart phone. In an embodiment the server receives a transport request from a remote device through an application programming interface (API).

In an embodiment the method includes the step of receiving a transport request from a marketplace.

In an embodiment the step of receiving a transport request comprises receiving a transport request from a marketplace.

In an embodiment the marketplace comprises a plurality of bids and offers. In an embodiment the marketplace comprises an order book. In an embodiment the order book comprises a plurality of bids and offers. In an embodiment the plurality of bids and offers are for a fixed unit of product. The fixed unit of product may be a measure of bulk material, or one or a plurality of animals. In an embodiment the marketplace is an auction marketplace.

In an embodiment the marketplace comprises a cost or price presented to a marketplace user; wherein the cost or price reflects the purchase price and transportation. In an embodiment the marketplace presents each user of the marketplace with a price personalised to the user. In an embodiment the cost or price is a bid or offer. In an embodiment the marketplace obtains or builds an order book comprising each of the bids or offers based on the location of a user.

In an embodiment transport users comprise the marketplace. In an embodiment the method comprises receiving a plurality of transport requests from the marketplace and obtaining a transport action for each of the plurality of transport requests; wherein the transport actions are used to create a cost inclusive of transport on the market place.

In a further aspect the invention may be broadly said to consist in a system for determining a transport action from transport provider data and at least one transport request, the system comprising:

A server adapted to communicate with at least one user terminal to receive information;

A data repository for storing data relating to the transport arrangements; and

A processor for obtaining a transport action

Wherein in use the server receives transport provider data from a transport provider; the transport provider data comprising availability for a future period of time for a plurality of transport vehicles;

Receives a transport request from a transport user terminal;

The processor obtains a transport action comprising at least one transport vehicle from the plurality of transport vehicles wherein a characteristic of the transport action approaches a selected value;

And the server receives confirmation of the at least one transport vehicle for the transport request; and updates the transport provider data to include the confirmed transport request.

In a further aspect the invention may broadly be said to consist in a method of communicating between transport resources, the method comprising:

Receiving transport provider data from a transport provider; the transport provider data comprising availability for a future period of time for a plurality of transport vehicles;

Storing the transport provider data in a data repository;

Receiving a transport request from a transport user terminal;

Communicating the transport provider data and transport request to a processor and obtaining a transport action comprising at least one transport vehicle from the plurality of transport vehicles wherein a characteristic of the transport action approaches a selected value;

Receiving confirmation of the at least one transport vehicle for the transport request; and

Updating the transport provider data on the server to include the confirmed transport request.

In a further aspect the invention may broadly be said to consist in a distributed marketplace for transportable goods, the distributed marketplace comprising:

a server adapted to communicate with a plurality of data sources; at least one of the data sources adapted to provide a transport cost to the server;

a storage device storing a plurality of bids and/or offers from one of the plurality of data sources;

a controller or control means adapted to select one, or a plurality, of the bids or offers and calculate a cost based on a transport location;

wherein the marketplace provides prices inclusive of transportation to the transport location.

In an embodiment the transport location is a user location. In an embodiment the user location is located by GPS or by entry in a remote terminal. In an embodiment the remote terminal output is a data source adapted to connect to the server. In an embodiment the remote terminal is a mobile electronic device such as a mobile phone or personal computer but the remote terminal may be any electronic device capable of connecting to the server.

In an embodiment the data source adapted to provide the transport cost is a data source using the method as claimed in aspects and embodiments herein.

In an embodiment at least one of the data sources comprises, or may be associated or coupled with a user input means. In embodiments the user is a transport provider or marketplace user.

In an embodiment the distributed market place comprises an order book, the order book comprising a plurality of bids and offers for the transportable goods and wherein the order book is dependent on, or related to, the transport location.

In a further aspect the invention may broadly be said to consist in a method of operating a marketplace for transportable goods, the method comprising

Receiving a request comprising a transportable good from a user terminal, the request comprising a specified location;

Obtaining a plurality of prices for the transportable good from a database or logistics engine; wherein each of the plurality of prices comprises a transport cost for the transportable good to the specified location; and

Sending the plurality of prices to the user terminal,

Wherein the marketplace is adapted to supply pricing dependent on the specified location in a request.

In an embodiment the user terminal is a personal electronic device such as a mobile phone or personal computer.

In a further aspect the invention may broadly be said to consist in a method of communicating between a plurality of devices to obtain a market price; the method comprising the steps of

Receiving a first request for a transportable good from a first user terminal, the request comprising a first specified location:

Storing the first request in a storage means;

Receiving a second request for the transportable good from a second user terminal, the request comprising a second specified location;

Obtaining a price for the second request, the price dependent on the first request and a transportation cost from the first specified location to the second specified location; and

Transmitting the price to the second user terminal;

Wherein a user at the second user terminal can confirm the second request at the obtained price including transportation costs.

In an embodiment the storage means comprises a plurality of requests including the first request.

In an embodiment the second request is coincident with at least one characteristic of the first request. In an embodiment the first and second requests match.

In an embodiment the first request is a bid or offer and the second request is a respective offer or bid. In an embodiment the storage means comprises a plurality of bids and/or offers and constructs, or is adapted to construct, an order book.

Embodiments of the invention described herein may be applied to any of the aspects described herein unless this is not possible.

The disclosed subject matter also provides a logistics system or a method of providing a logistics system which may broadly be said to consist in the parts, elements and features referred to or indicated in this specification, individually or collectively, in any or all combinations of two or more of those parts, elements or features. Where specific integers are mentioned in this specification which have known equivalents in the art to which the invention relates, such known equivalents are deemed to be incorporated in the specification.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a schematic of the system including each of the portions shown in FIGS. 2 to 4.

FIG. 2 is a schematic of an embodiment of system showing the interface between the transport providers and the system as shown in FIG. 1.

FIG. 3 is a schematic of an embodiment of system showing the interface between the transport users and the system in FIG. 1.

FIG. 4 is a schematic of an embodiment of system showing the interface between the marketplace and the system in FIG. 1.

FIG. 5 is an example screenshot of an embodiment of the system wherein a plurality of orders are tracked.

FIG. 6 is an example screenshot of an embodiment of the system wherein a user can insert a request for transport.

FIG. 7 is an example screenshot of an embodiment of the system wherein a quote is received.

FIG. 8 is an example screenshot of an embodiment of the system wherein a user can select a range of pick-up times.

FIG. 9 is an example screenshot of an embodiment of the system wherein a user confirms a transport action.

FIG. 10 is an example screenshot of an embodiment of the system wherein a user has accepted an action and is provided an indicative delivery.

FIGS. 11a, 11b and 11b are example screenshots of a delivery showing the details of a delivery in (a) short and (b) time scaled forms.

FIG. 12 is an example screenshot of an embodiment of the system wherein a vehicle availability can be set.

FIG. 13 is an example screenshot of an embodiment of the system wherein a known job can be inserted into the system.

FIG. 14 is a schematic of a transport resource or vehicle and multiple pick-up or drop-off locations.

FIG. 15 is a diagrammatic representation of an embodiment of the components of the system.

### DETAILED DESCRIPTION OF THE DRAWINGS

Throughout the description like reference numerals will be used to refer to like features in different embodiments.

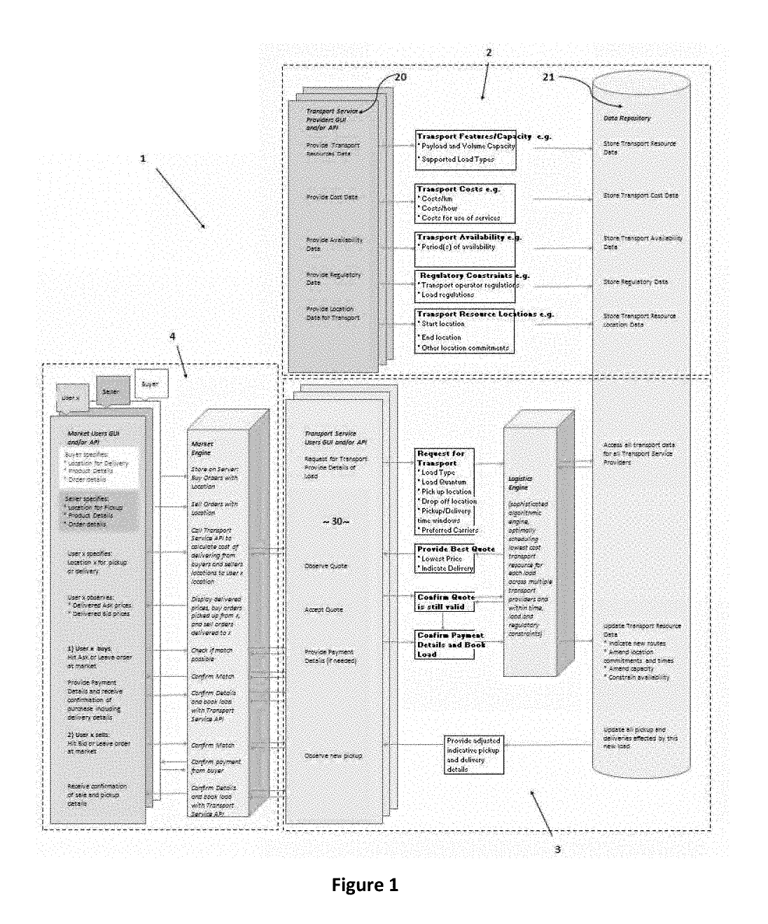

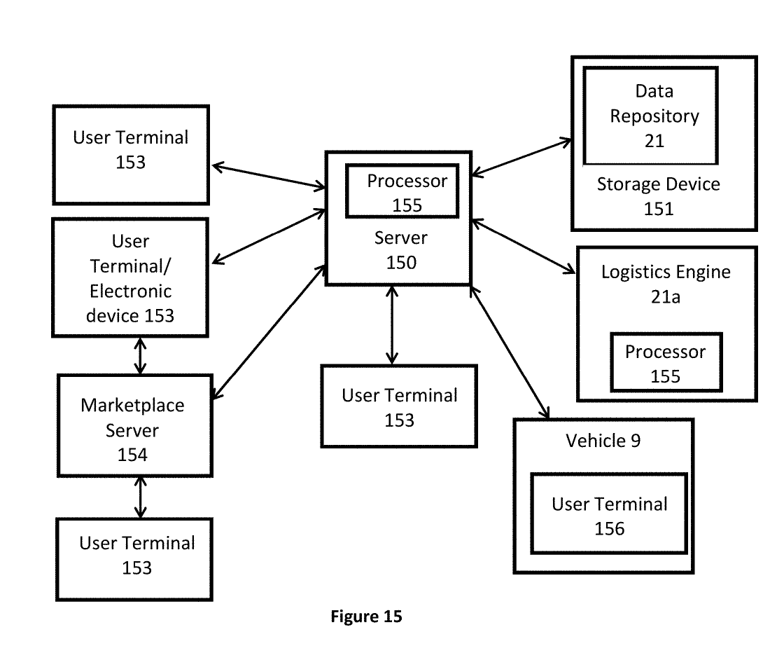

Referring to the drawings, and first to FIG. 1, a schematic diagram shows the arrangement of the system for logistics or transportation management 1. The system 1 enables a plurality of transport providers to communicate their services effectively to a plurality of transport users. In further embodiments a marketplace interfaces with the system, in particular with the transport users subsystem, to provide further functionality to the system. The system is separated into 3 subsystems for the ease of description; however those skilled in the art to which the invention relates will appreciate other possible subsystem arrangements may be implemented. The system and subsystems may be implemented on a computer system such as a server 150 (refer to FIG. 15) having at least one processor 155. The computer system may be connected or connectable to user terminals 153 by wired or wireless means or via a network. The server may include a processor 155 and hold the data repository 21 and the logistics engine 21a, or may be connected to a further processor or processor means 156 comprising the logistics engine or a storage device 151 which may contain data repository 21.

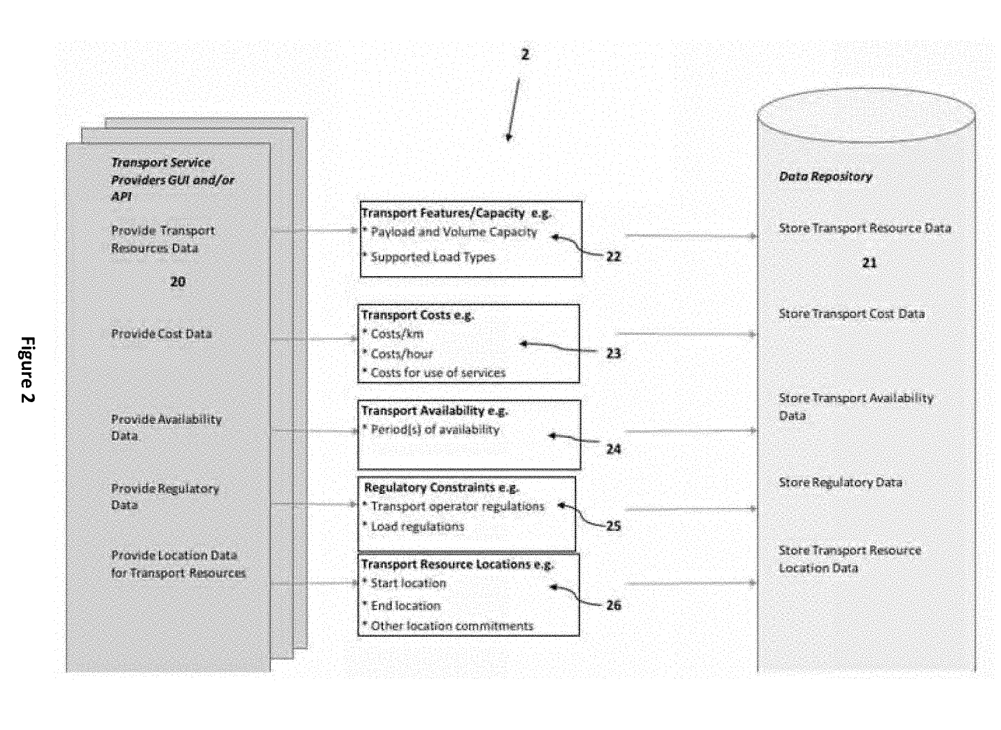

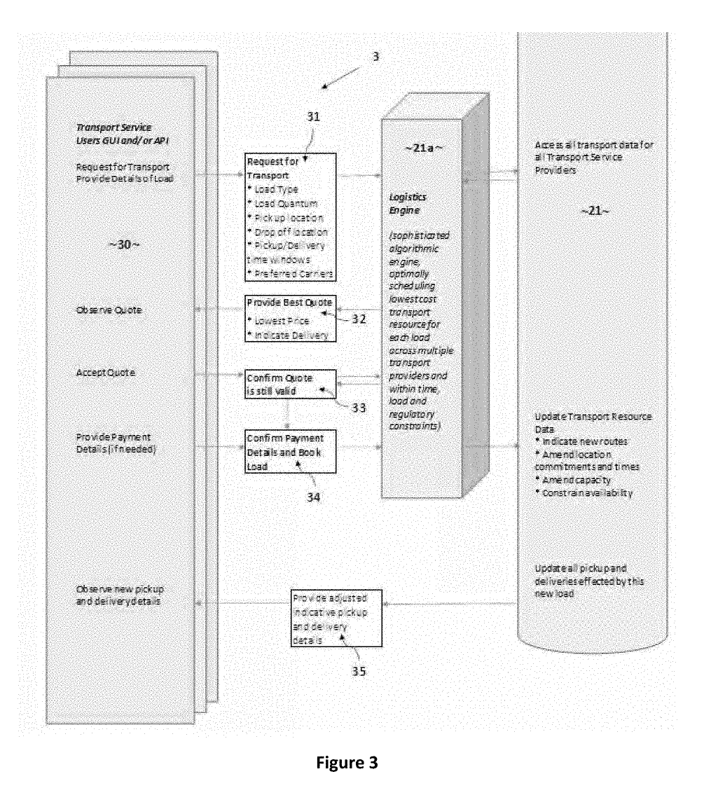

A first subsystem, the provider subsystem 2, provides the communication between transport providers 20 and the repository 21. A second subsystem, the user subsystem 3, provides the communication or communications means between the transport users 30 and the repository 21. The communications within the subsystems, or between the parts of the subsystems, are discussed in more detail in the FIGS. 2 and 3.

Subsystem 4, a product or goods marketplace subsystem, provides a marketplace front to the logistics management subsystems 2, 3. The marketplace 4 may be created independently of the logistics system but is preferably integrated, including links to the server 150.

Referring now to FIG. 2 more detail is provided regarding the provider subsection 2. The transport providers 20 are providers of at least one, but preferably a plurality of transport vehicles or resources 9. In the described examples the vehicles 9 are trucks and may be referred to as such herein; however other transport vehicles 9 including without limitation ships, vessels, aircraft or may also be provided. The transport vehicles may have a user terminal 156 to access the system and/or receive updates to the system. The transport providers 20 are preferably freight providers who have, for instance, a plurality of trucks at a plurality of locations around a geographical region, state or country. The transport providers 20 supply a selection of information to the system and/or server 21. This is preferably in a per truck or vehicle format 22. That is to say each truck location 26, features, payload, volume capacity and load type would be uploaded. Any prior commitments and/or a period/s of availability 24 would also be uploaded. The availability would be uploaded for the present until a future time. The system 1 is therefore able to suitably allocate the transport services over a period of time. The use of a period of time enables multiple trips or actions to be combined and future positions of trucks 9 to be considered.

The transport provider 20 may also provide a set of costs 23 or tariffs for the vehicles. The costs are preferably uploaded in a per unit distance, or per unit time manner. There may be further costs for specific actions to be performed by the vehicles—for instance, cleaning of the vehicle or overnight stays. These costs may be set across the fleet, specific to each vehicle, or set for particular groups of vehicles. The system may also allow transport providers to provide constraints on the use of their transport vehicles. Constraints may include: regulatory requirements 25; load regulations; or transport operator regulations. For instance, there may be regulations specific to driver fatigue, load perishability, temperature control, regulatory requirements, or animal safety. Any features not specified by the transport provider 20 may default to system values, regulatory requirements, or may default to the largest or maximum price. In preferable embodiments the provided data can be updated by the transport providers in real time, or at a regular interval. This data may then be applied to any future transport or transport modification. If values are not available the system may request updates from the transport provider 20.

The system 21 receives the data provided by a transport provider 20 and is able to build a store of available transport resources or vehicles 9. The system now has a list of available vehicles with specific locations and information regarding any required waypoints or endpoints. This information can be used to determine an optimum route. Where an optimum route is discussed the route may simply be one of a selection of preferred routes which minimises a particular feature, such as but not limited to cost. The preferred route may also be specified by another means which relates to the minimisation or maximisation of a particular value, or when a value approaches a preferred value, which may be zero. The optimisation may be through, or may use or comprise an artificial intelligence or machine learning method. In an embodiment, artificial intelligence comprises operations research techniques to solve the optimization problems. These techniques may include simulation, mathematical optimization, queueing theory, or neural nets. In an embodiment the techniques comprise the application of machine learning to an optimization problem.

FIG. 3 shows the user subsystem 3 in more detail. The user subsystem comprises a user 30 and a system or server 21. The user is simply an entity who requires transportation of a resource 8 from one location to another. The resource described herein by way of example is animals or stock, however the system is not limited to this resource and may include vendible products, people, packages or other transportable items. An example will now be provided in which the resource of load is a plurality of animals. The transport user 30 enters, and/or the system receives, a request for transport with a number of criteria. The criteria are preferably few, so that the system has increased flexibility to provide the best quote or price. The request 31 may include a load type (e.g. cattle), load quantum or number (e.g. 40), pick-up and drop off locations. In some embodiments the user can also specify which carrier is preferred. Further details or constraints may be provided on request of the system or by the user. In an embodiment the system may highlight, or propose constraint amendments (e.g. time or size of transportation action) that, if made, would reduce cost.

The user subsystem 3 also shows the logistics engine 21a. This is preferably located with the server or system 21, but may be linked or communicated to in a separate location. The logistics engine 21a combines a sophisticated algorithmic engine which is able to process the transport requests from users 30 of the system and schedule a plurality of requests between a plurality of the transport vehicles 9. The system can be optimised to produce a lowest cost transport schedule based on the available parameters and/or constraints. In particular the logistics engine is designed to combine separate transport requests, of the same or distinct, users, in one transport vehicle, or one journey of a transport vehicle. For example, consider a truck which is based in Washington D.C. and receives a fully laden journey to New York. The logistics engine would know the movement of the truck and would target the backhaul between New York and Washington D.C. as a low cost transport route for a second transport request. In this manner the efficiency of the transport system can be improved by, in part, ensuring that as much as possible transport actions use trucks which are already travelling and have unused capacity.

The user subsystem 3 also provides a communication system from the server or system 21 to the user. The communication includes the provision of a best quote 32 which may also indicate the delivery time. This and the other communication may be provided by email, through a web application or through an android, apple or other operating system application or by mobile telephony. The communication may be to a user terminal 156 or other electronic device, including a mobile device. The communication also allows the transport user to accept the quote or costing 33 or may be adapted to automatically accept a quote based on predefined criteria, for instance on a sale in an associated marketplace. The communication may also include a confirmation 34 including details, of payment transactions, confirmation and booking details. In preferred embodiments of the system, the system may review a transportation action and update the transportation action. As described in more detail below this may be used to decrease an overall cost of the system, or the particular cost of a transport action. Where an adjusted or amended transport action is used the system may communicate this to a user. This communication could be an email or communication through an application or may use a SMS message, or messaging over wireless communication system such as mobile telephony. In a preferred embodiment the system comprises user applications allowing a user to view the current status and expected deliveries of the associated transport action.

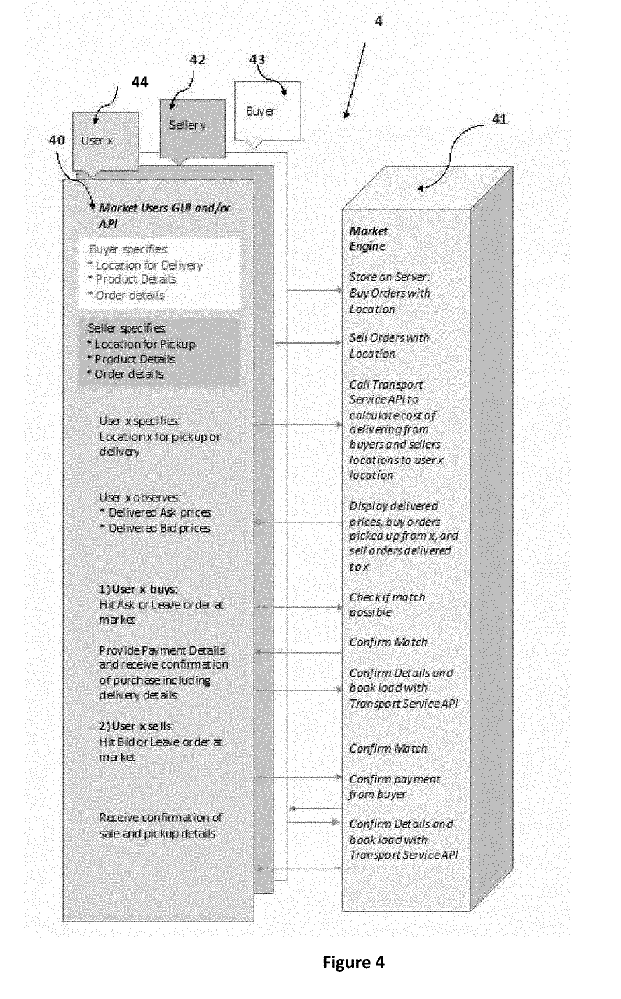

FIG. 4 shows the marketplace subsystem 4 which can optionally be combined with the system. The marketplace has a plurality of buyers 43 and/or sellers 42. The buyers and sellers may be collectively referred to as users 44; a user may also refer to an authorised marketplace user. Buyers and sellers specify locations and product details enabling user orders to be generated. The user orders interface, typically through the market engine; as user requests 20 in the system. This enables the logistics system to calculate a price, preferably the minimum price, for the transport of the market product(s). In the preferred embodiment this price is incorporated into the buy or sell or, bid or ask, price on the market. That is to say, a buyer looking at the marketplace will see the current buy/sell or auction price for shipping to his location. Similarly the buyer 43 will bid at an all-inclusive price for shipping to them. In this way each user of the system receives a view of the marketplace personalised to their delivery location. In a preferred system the market place builds a summary, or order book, consisting of a plurality of bid and asking prices for a particular product, all including transport costs. The market engine 41 may be located on the same server 150 as the logistics engine, or may simply interface to the logistics engine 21a or the API of the transport users 30.

In a further embodiment the method includes the use of a marketplace in which costs in the marketplace are presented to a user terminal 153 accessing the marketplace dependent on transport to a location. Preferably the location is the location of the user terminal 153, but alternatively the location may be a third location separate from the server 150 or user terminal 153. In an embodiment the location may be set or selected by the user. In a preferred embodiment the marketplace is adapted to present a personalized display to each user based on location. That is, each price on the marketplace is for delivery to that user at the selected address and the user enters a price which is the price they will receive and is presented to further users with an additional delivery cost. This enables each user to view the distributed marketplace neutral to distance. This avoids earlier systems which required users to calculate or estimate delivery costs and made finding the best cost difficult. In a preferred embodiment the market place calculates the adjusted costs (including delivery) before presenting any prices to the user. In an embodiment the raw market prices (e.g. unadjusted for transport) are not visible to the user.

In an embodiment the marketplace comprises a server 154 adapted to communicate with a plurality of user terminals 153. Each user terminal may be a personal electronic device such as a mobile phone or personal computer. At least one of the user terminals has an access to the server in which the user can view information contained on the server, or in a storage means (e.g. ROM, RAM or other data storage device) associated with the server. A user can access the data through the user terminal and view each of a plurality of bids or offers in the marketplace. The bids or offers may be for a particular transportable good, or for a unit of a transportable good (e.g. a measure of bulk goods or a number of animals/units). In a preferred embodiment the bids and offers form an order book of the current distributed marketplace. In embodiments of the system the marketplace server or set-up may be shared by the system or a similar arrangement may be used by the system.

Therefore, the communication method provides an advantage because a user can instantly see the marketplace from their location, instead of having to communicate separately to link a marketplace to their location. This communication method enables the server to form a market order book from bids and offers separated at various distances. Without including the transport prices this order book would not be possible. Simply matching prices between bids and offers without transport included may result in a very cheap offer. However the cost of transporting that offer, when calculated, may substantially increase the offer so that it was not the ‘best’ offer. In an alternative embodiment the marketplace may be an auction site and the bids may be a list of earlier auction prices. This would allow a user to bid and view prices inclusive of exact transport costs.

The method preferably uses a transport system substantially as herein described, wherein the transport prices are quoted substantially instantly and at a set amount dependent on the exact transportation route. The logistics or transportation system may reside on a further server in communication with the marketplace server or be on the same server as the marketplace. The transport server comprises further input data sources allowing user terminals associated with transport providers to add details regarding their transport vehicles or trucks to the system. This data may include the trucks availability and location for a future period of time. Preferably this period of time is at least 1 or 2 days, or may be 7 or 10 days or more. There is not necessarily an upper limit. The logistic engine or system may operate independently of the market (i.e. the logistics system has users and one of the users is the market) or may be a system only for the marketplace.

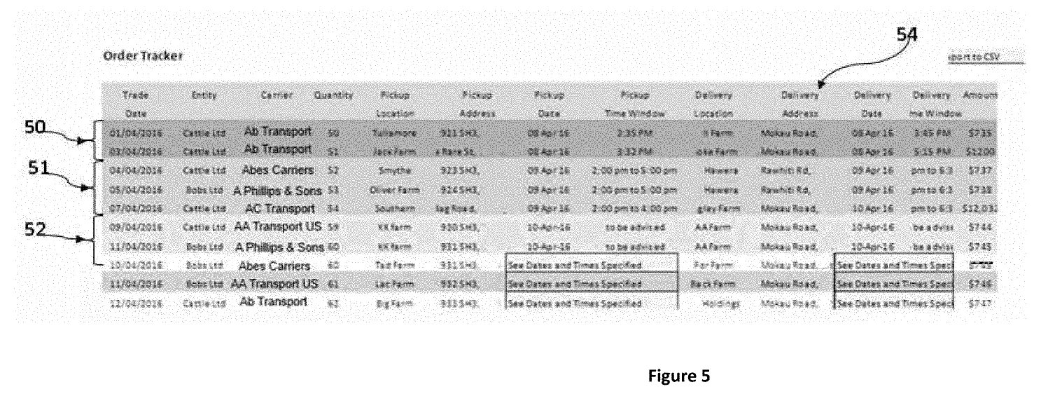

FIG. 5 shows an embodiment of the system 1 wherein the orders are tracked. This system would typically be saved on the server. However users or providers of transport would preferably have access to the system either when connected and/or in a persistence link to their user terminal 156/153 (such as a computer system or mobile phone). In this way they have access to required details even without a communication link to the system. FIG. 5 shows different groupings in the upcoming actions table 54. The actions can be prioritised based on date. For instance preferred embodiments of the system provide forecasted transportation for a period into the future, for instance 10 or 20 days.

As the system is able to combine actions, or rebook actions to improve overall efficiencies, the details of a transport action may change from the date of confirmation to the date of delivery. In the shown embodiment three groups of actions are shown. The first transport actions 50 are those closest to the delivery time, these have been confirmed with transport users but are subject to change. When the transport action is within a time limit of the pick-up (e.g. 48 hours) it is moved to a fixed day 51. The pick-up group have a fixed time window i.e. a fixed day of pick-up. When the transport action is within a second time limit or window of the pick-up (e.g. 24 hours), normally closer than the first time limit then the time of the pick-up is moved to a fixed time and day group 52. At each of the groups a communication or message may be sent to a transport provider or transport user confirming an aspect of the transport action. This is preferably sent over a mobile network to ensure it is received by a user, but may be sent through email, or through an application. This example has considered the pick-up times and deliveries, however a similar process can be applied to the delivery times (where these are not set) including notification when confirmation occurs. Further to this the pick-up and delivery times may be updated by position tracking of the driver and or vehicle 9, for instance by GPS or wireless detection tracking. In some embodiments the time limits for pick-up or delivery confirmation times are set by users or providers, or default system values are used. The use of tracking may provide current or historic location information which is used to adjust the first and second time windows referred to above.

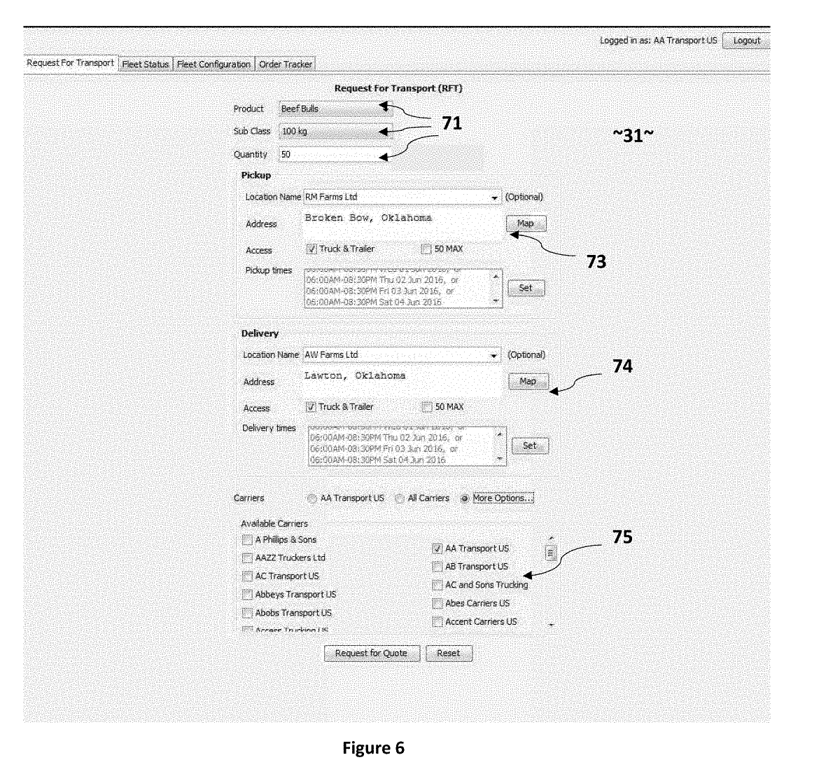

FIG. 6 shows an example transport request screen for a user 20 of the screen. The transport request 31 screen includes a description of the product and quantity 71. The system also allows a user to place requirements on the system, such as access limits. The system also allows a user to restrict options available to the system in calculating a lowest cost option, such as nominating which transport provider or carrier to use 75. This may be through the selection of a single carrier, or the selection of carriers which may or may not be used or may be preferred. The user must also provide a location for pick-up 73 and delivery 74 of the product or resource. Constraints of the locations can also be provided such as access possibilities or delivery times.

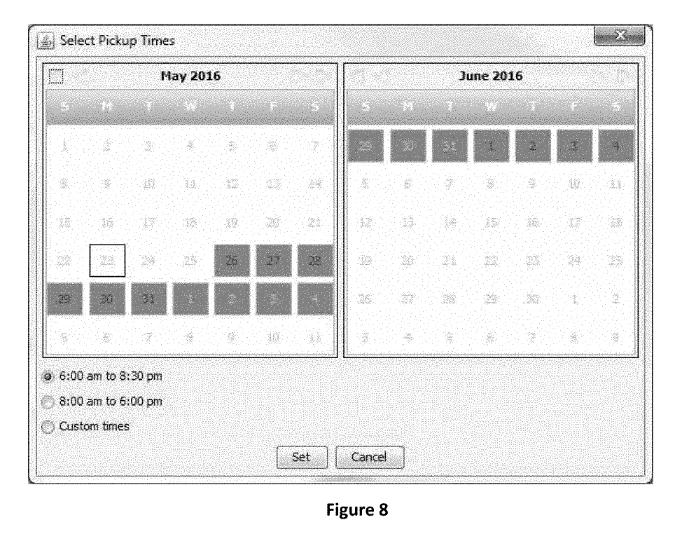

FIG. 8 shows an embodiment of the system in which a transport user requests times for pick-up (a similar embodiment may be available for delivery). The system allows particular days to be selected, and may provide a time range, or a custom set of times. The transport request screen may include entry points for category of product, product, subclass, quantity, pickup and drop off location and times, location characteristics and access limitations and carrier selection. The location can be selected from a drop down menu, or added by using address and/or coordinates.

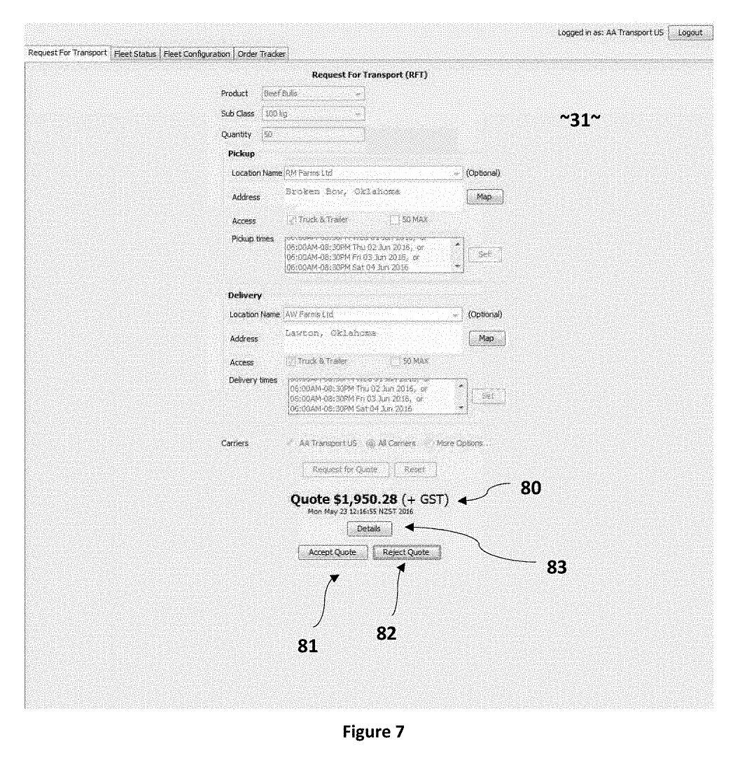

FIG. 7 shows the outcome of the transport request. The user has submitted the transport request 31 as shown in FIG. 6. The logistics engine 21a has then scheduled the transport request 31 based on the available transport resources 9. This includes at least current vehicles with known routes, or partially filled routes, returning vehicles and empty vehicles with known start points and required endpoints. In preferable embodiments the system also includes transport vehicles 9 which act as a store, and are available to bring in to schedules when no current vehicles are available or cost effective. The transport action 80 is provided on the outcome page. In the shown embodiment only the overall cost is provided, although further details 83 are available. The transport user is given the option to accept 81 or reject 82 a quote. In preferable embodiments the transport user 20 is unable to modify add or view the details of a transport action except by changing the transport parameters on the transport request screen. This avoids a transport user reducing the cost effectiveness, or optimisation, of a quote. In some embodiments transport users will be given an additional option to “Leave Order” rather than just Accept or Reject Quote. A pop-up may open asking the customer to enter a dollar or cost amount they are happy to leave the order at and a time limit on the order (e.g. 3 days).

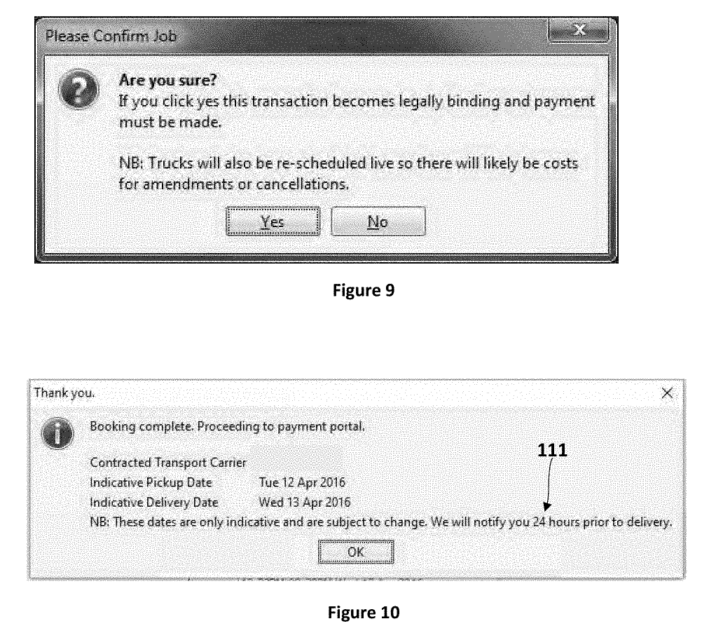

FIGS. 9 and 10 show confirmation screens; in a preferred embodiment the confirm job screen is used after a transport user accepts a transport action. The confirm screen may inform a user that because the system reconfigures future transports based on their transport action additional costs may be incurred if amendments or cancellations are made. However FIG. 10 identifies the preferable embodiment in which the system is able to provide indicative delivery dates and times and the time of the transport action confirmation but may later adjust, combine or review transport actions to improve the efficiency of the system, or lower the cost of other transport actions. A time-limit 111 for the recalculation before delivery (e.g. group 50) may be displayed to alert the transport user of when confirmation of the timing will be communicated.

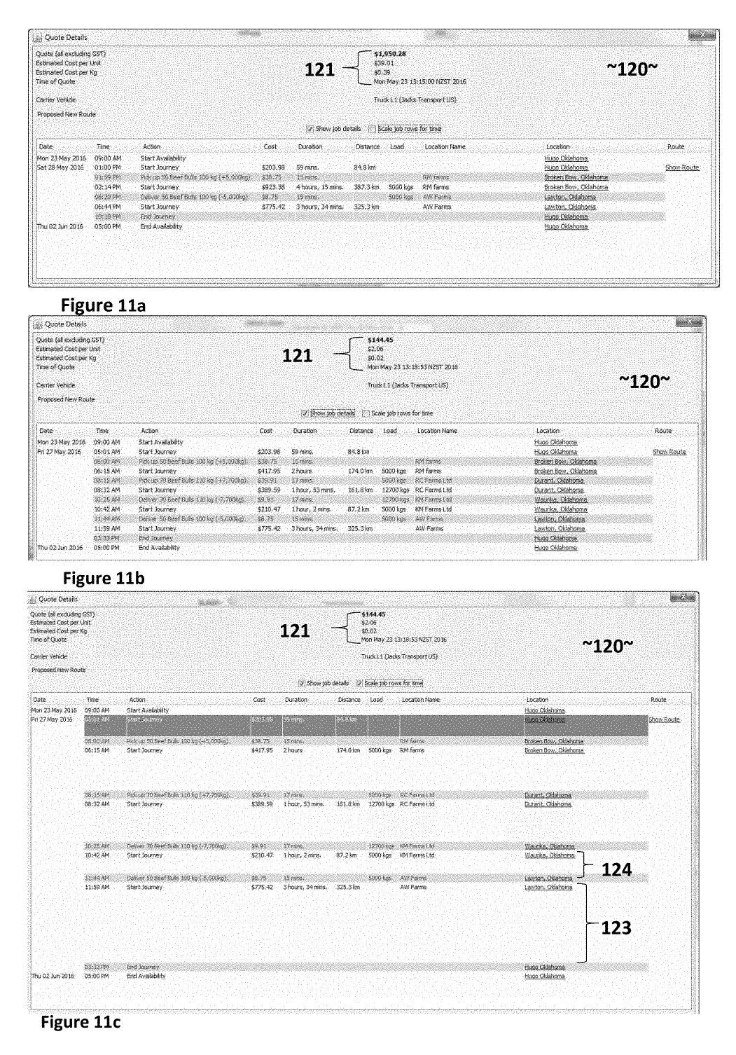

FIGS. 11a, b and c show the details of a transport action in an embodiment of the system. This may be available to a user, transport provider or other part of the system as required. The detail 120 of the transport action includes a summary of the quote and time of the quote 121. FIG. 11a shows a particular transport action in Oklahoma between Broken Bow and Lawton, returning to Hugo with each leg listing the details.

However it is noted that the transport action has resulted in an empty truck on the return leg from Lawton to Hugo. In a typical system this would be lost time and wasted efficiency. However in the present system the return leg is available for further transport actions. Furthermore the present transport action can be adjusted or amended within its constraints to improve the use of the transport resource 9. For instance if there were 30 Bulls to be transferred from Lawton to Hugo on the 29 May 2016 the present transport action could be advanced so that the truck arrived in Lawton on 29 May and could pick up the second load. Further loads could also be added where possible. In further embodiments the vehicle may be redirected to different locations, increasing the length of a particular delivery but allowing deliveries to be combined. In a further embodiment a truck may combine deliveries. For instance Truck L1 may be able to carry 25000 kgs. Therefore it could transport a second job from Lawton to Hugo of up to 20000 kgs while completing the current job. The present system is able to achieve this matching and combining of loads in part because it requires communication of availability and location for a future period of time. This enables the system to modify the transport actions to provide the group of transport actions, instead of relying on the best single transport action at a particular time. Embodiments of the system allow aggregating availability of transport providers and of transport resources to be incorporated in the optimization, providing an improved transport action.

FIG. 11b demonstrates how the system can add additional transport actions and update transport actions based on the updated transport action. In this example the system has received a further order for delivery of 70 transportable goods (beef bulls) from Durant to Waurika. The date range for this transport request includes 27 May 2016. A new truck could be used for this delivery, or the delivery could use the same truck after the completion of the first transport action. However the more cost efficient route can be calculated by reviewing the stored information or data provided about truck availability and journey flexibility. The system can find that the truck is available up to the 2 Jun. 2016 and that the first transport action (50 cows to Lawton) can be performed a day earlier. Then the system can review the truck data and find it can hold both transport actions. The method then allows the details of the first transport action to be amended, as shown in FIG. 11b, so as to start on 27 May 2016. This enables both transport actions to use a single truck, picking up each set of bulls in turn and dropping them off.

While the change has increased the length of the original transport action the overall effect is much more efficient, in terms of truck usage and time, and therefore the cost can be reduced. This means that the cost of the second transport action is less, but also allows the method to discount the first action, due to the truck now being shared for at least a portion of the journey. This cost reduction may be dependent on the actual difference in cost of the transport action in each case. That is to say the cost difference can be calculated between the two separate transport actions or deliveries and the combined transport action and be prorated between the two transport actions. In other embodiments the rearrangement may change the time of delivery, redirect the truck to a rest stop, or may share a load between different trucks. As the truck remains available until 2 June it may be used in further transport routes. The final confirmation of the transport actions may be confirmed in the future, preferably 24 hours or 1 day before the transport action but as little at 1 hr, or as much as 10 or 15 days or more if required.

In alternative examples a user may request a change to a transport action. The system can then be optimized for the change or amendment to the transport action and a cost can be calculated. This cost may be an increase or decrease from the original cost to the user for the transport action, depending on the availability of trucks within the system. Following the amendment the costs difference may be passed on to the user as a refund or rebate or an additional charge to the user.

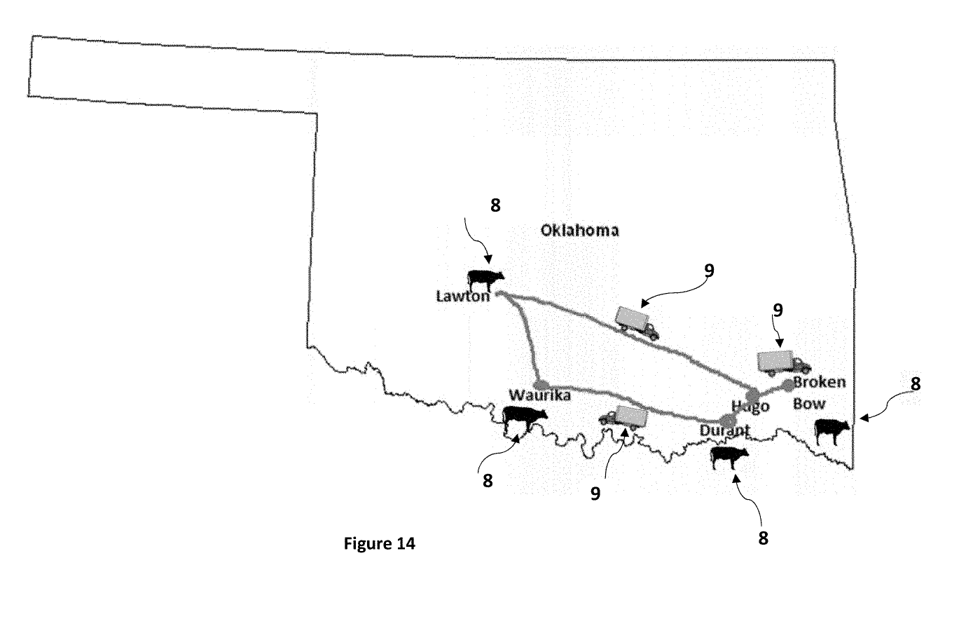

FIG. 11c shows the same details but each leg is now expanded to show the time taken for each segment. For instance the travel time from Lawton to Hugo 123 is longer than the travel time from Waurika to Lawton 124. In the particular transport action a truck from a transport provider, Jacks Transport US is shown as available between the dates of 23 May and 2 Jun. 2016 based in Hugo, Okla. The transport action is for the two deliveries of 50 Bulls from Broken Bow to Lawton and 70 Bulls from Durant to Waurika. The transport action has been routed, preferably in the most efficient manner, between the start location of the truck, the pick-up location, the drop off location and back to the end location of the truck. In this case the same as the start location (Hugo). A number of systems could be used for route calculation, such as Google™ maps. The system is shown in diagrammatic form on a map of Oklahoma in FIG. 14.

A feature of the system as shown in FIGS. 11a-c is that the system allows fluidity in the scheduling of the transport resources and transport actions. That is to say, the system has fixed criteria but also has unfixed criteria (and the transport users and or providers may be able to nominate fixed or un-fixed criteria). For instance a customer may select a particular carrier or transport provider. However, if a customer is not specific about which carrier to use the system may select an initial carrier when the job is quoted. However the system maintains the flexibility to change the carrier to provide a better solution. For instance, this may occur when additional transport actions are incorporated into the system, or when new transport resources 9 are added by transport providers. The system is particularly flexible about the timing of transport actions. The system takes advantage of requiring a forward looking calendar to provide an additional dimension of flexibility, that is the ability to delay or speed up transport actions. This change in the time of actions allows jobs to be combined in a synergistic manner, while working within the constraints of fixed access to transport resources. The system also gains from holding all, or substantially all key information at a centralised point or server 150 or data repository or location 151, 21. This enables the server to make accurate decisions based on all the required data instead of relying on partial data, or cost estimates from individual transport providers.

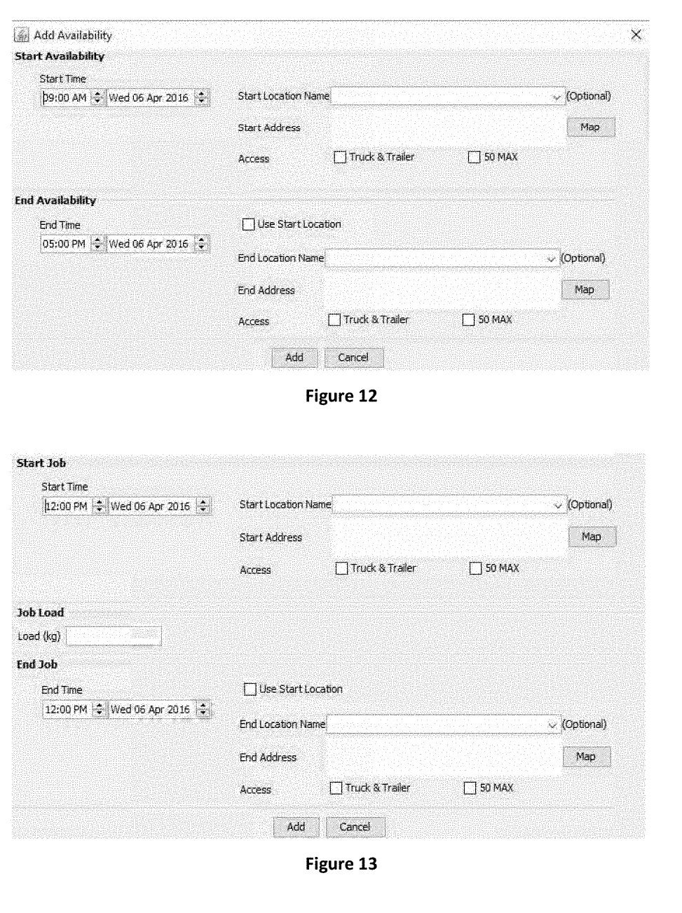

FIG. 12 shows an example screen for the entry of availability data for a transport resource 20. In some embodiments this may be automatic through direct communication with the transport provider computer system. The screen prompts the transport provider to define Start Availability Time and Date plus the Start Location and the End Availability Time and Date and the End Location. In some embodiments there is also a check box to use the start location as your end location. The system then provides a schedule for the transport resource. This is calculated across the availability, but the actual schedule may not be available until shortly before the start availability time, and may change during the availability time as new transport actions are included.

Drivers or operators of the transport resources can be provided copies of their schedule on mobile electronic devices or user terminals 156. These may be mobile phones, or may be contained in the transport vehicles. The electronic devices may also be used by the drivers to update their availability times and locations. In some embodiments non registered loads may also be recorded. In a preferred embodiment 156 the schedule is available when the mobile electronic device or user terminal 156 is not connected to the system. This enables a driver to know what they are doing even when they have no cellular connection. In some embodiments the mobile device will indicate confirmed schedule items and provisional schedule items, (e.g. by colour) so that an operator is required to confirm a schedule item before beginning that portion of a transport action. The offline mobile device may also be used to record receipt of goods. For instance the driver may get an on screen signature from a customer upon delivery of goods on a mobile device carried by the driver. This would then update the Order status to showing POD when the electronic device contacts the system.

FIG. 13 shows an example embodiment in which a non-system job (e.g. a job that is not generated by a transport request) could be added to the system. This allows a user to add a transport vehicle location to the system without using the system scheduling. This may be advantageous in increasing the number of transport vehicles in the system and providing more efficient combination of transport actions.

The system has a plurality of constraints. The constraints may broadly relate to physical constraints, regulatory constraints or constraints of the system or optimisation process. Physical constraints include the computability of locations and trucks, or of a resource and transport vehicle. Physical constraints also include access locations and delivery issues. Regulatory constraints are typically imposed from a government office or similar authority. However in other cases a user or transport provider may apply additional constraints, such as limiting the amount of time an animal can be transported for. System constraints may be applied by the system to reduce the complexity of the logistics engine, or to ensure that certain criteria are met by the solution or in the optimisation process. Although the constraints have been separated into groups it would be understood that many of the constraints may be applied, entered or adjusted at different parts of the system, or by different users, except where this is not possible.

According to preferred embodiments, a processor or processors 155 are provided that adapt the transport actions to provide an optimized system comprising the plurality of transport actions. This optimization may be available to a user or operator, but preferably only the resulting action is available to a user at a remote user terminal. More particularly, the processor(s) may include logic to facilitate the optimization of the logistics system. The invention further provides for the processor(s) and/or other processor(s) and/or a user (preferably an administrator level user) to make variations to parameters associated with implementation of the optimization of the invention, possibly through a user terminal 156. For example a category of users may be preferred over other users when transport actions are rearranged or adjusted or the means of communicating to system users may be changed (e.g. text messages may be sent rather than emails or a phone/user terminal application). Such variations may be implemented across the board but may be limited to a subset of users and/or for a period of time.

From the foregoing it will be seen that a transport system is provided which enables a user to obtain services from one of a plurality of service providers.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

1. A method for determining transport actions, the method comprising:
receiving transport provider data from a transport provider; the transport provider data comprising availability for a future period of time for a plurality of transport vehicles;
storing the transport provider data on a server;
receiving a transport request from a transport user;
obtaining a transport action comprising at least one transport vehicle from the plurality of transport vehicles wherein a characteristic of the transport action approaches a selected value;
receiving confirmation of the at least one transport vehicle for the transport request; and
updating the transport provider data on the server to include the confirmed transport request.

2. The method of claim 1 further comprising identifying a future location of the at least one transport vehicle at a future time from the transport request, and adding the future location to the transport provider data.

3. The method of claim 1 or claim 2 further comprising identifying a future capacity of the at least one transport vehicle at a future time from the transport request, and adding the future capacity to the transport provider data.

4. The method of any one of the preceding claims further comprising storing transport actions for a plurality of transport vehicles in a per vehicle manner.

5. The method of any one of the preceding claims further comprising receiving transport provider data from a plurality of transport providers.

6. The method of any one of the preceding claims wherein the characteristic of the transport action comprises any one or more of the following:
Time;
Cost;
Efficiency;
Vehicle usage;
Vehicle capacity; and
Vehicle distance travelled.

7. The method of any one of the preceding claims wherein the selected value is a maximisation or minimisation.

8. The method of claim 1 wherein the step of obtaining a transport action comprises applying an action constraint.

9. The method of claim 8 wherein the action constraint is based on one or more of: animal welfare; perishability of load; regulatory constraints; vehicle driver time periods; vehicle maintenance periods; restricted time periods; refrigeration or temperature control.

10. The method of any one of the preceding claims wherein the future period is at least 1 day; or 7 days; or 10 days.

11. The method of any one of the preceding claims further comprising the steps of receiving a second transport request and using the second transport request to obtain a second transport action comprising at least one transport vehicle from the plurality of transport vehicles to reduce a characteristic of the second transport request.

12. The method of claim 11 the second transport action affects, or is affected by, the first transport action.

13. The method of claim 12 wherein the second transport action and the first transport action comprise at least one common transport vehicle.

14. The method of any one of claims 11 to 13 further comprising the step of amending a characteristic of the first transport action.

15. The method of claim 14 further comprising adjusting a cost of the first transport action.

16. The method of claim 15 further comprising crediting, refunding or rebating a cost difference resulting from the adjusted cost.

17. The method of any one of the preceding claims further comprising providing details of the transport action to the transport user.

18. The method of claim 17 further comprising providing the details to a mobile device.

19. The method of any one of the preceding claims wherein the transport vehicle is tracked to provide current and/or historic location information.

20. The method of any one of the preceding claims further comprising providing a request constraint comprising any one or more of the following:
Times or date of delivery;
Time or date of pick-up;
Regulatory constraints;
Amendment limitations;
Access limitations and
Preferred carriers.

21. The method of any one of the preceding claims wherein the transport provider data comprises any one or more of the following:
Cost per unit distance;
Cost per unit time;
Cost per vehicle action;
Vehicle payload and volume capacity;
Vehicle payload types;
Vehicle start location;
Prior vehicle transport actions;
Vehicle end location;
Vehicle home location;
Vehicle regulations; and
Vehicle load regulations.

22. The method of any one of the preceding claims further comprising the step of receiving a transport request from a marketplace.

23. A system for determining a transport action from transport provider data and at least one transport request, the system comprising:
a server adapted to communicate with at least one user terminal to receive information;
a data repository for storing data relating to a transport arrangement; and
a processor for obtaining a transport action
wherein in use the server receives transport provider data comprising availability for a future period of time for a plurality of transport vehicles from a transport provider, and a transport request, and;
a processor to provide a transport action comprising at least one transport vehicle from the plurality of transport vehicles wherein a characteristic of the transport action approaches a selected value;

24. A method of communicating between transport resources, the method comprising:
receiving transport provider data from a transport provider; the transport provider data comprising availability for a future period of time for a plurality of transport vehicles;
storing the transport provider data in a data repository;
receiving a transport request from a transport user terminal;
communicating the transport provider data and transport request to a processor and obtaining a transport action comprising at least one transport vehicle from the plurality of transport vehicles wherein a characteristic of the transport action approaches a selected value;
receiving confirmation of the at least one transport vehicle for the transport request; and
updating the transport provider data on the server to include the confirmed transport request.

25. A distributed marketplace for transportable goods, the distributed marketplace comprising:
a server adapted to communicate with a plurality of data sources; at least one of the data sources adapted to provide a transport cost to the server;
a storage device storing a plurality of bids and/or offers from one of the plurality of data sources;
a controller or control means adapted to select one, or a plurality, of the bids or offers and calculate a cost based on a transport location;
wherein the marketplace provides prices inclusive of transportation to the transport location.

26. A method of operating a marketplace for transportable goods, the method comprising
receiving a request comprising a transportable good from a user terminal, the request comprising a specified location;
obtaining a plurality of prices for the transportable good from a database or logistics engine; wherein each of the plurality of prices comprises a transport cost for the transportable good to the specified location; and
sending the plurality of prices to the user terminal,
wherein the marketplace is adapted to supply pricing dependent on the specified location in a request.

27. A method of communicating between a plurality of devices to obtain a market price; the method comprising the steps of
receiving a first request for a transportable good from a first user terminal, the request comprising a first specified location:
storing the first request in a storage means;
receiving a second request for the transportable good from a second user terminal, the request comprising a second specified location;
obtaining a price for the second request, the price dependent on the first request and a transportation cost from the first specified location to the second specified location; and
transmitting the price to the second user terminal;
wherein a user at the second user terminal can confirm the second request at the obtained price including transportation costs.

28. (canceled)
